(19) United States
(12) Patent Application Publication
(10) Pub. No.: US 2014/0212105 A1
(43) Pub. Date: Jul. 31, 2014

(54) RECORDING DEVICE AND METHOD FOR RECORDING PROGRAM

(71) Applicant: HON HAI PRECISION INDUSTRY CO., LTD., New Taipei (TW)

(72) Inventors: PEI-YING WANG, New Taipei (TW); JIAN-SHIHN TSANG, Tu-Cheng, New Taipei (TW)

(73) Assignee: HON HAI PRECISION INDUSTRY CO., LTD., New Taipei (TW)

(21) Appl. No.: 14/063,181

(22) Filed: Oct. 25, 2013

(30) Foreign Application Priority Data
Jan. 28, 2013 (TW) 102103111

(51) Int. Cl. H04N 9/79

(52) U.S. Cl. CPC H04N 9/79
USPC 386/230

(57) ABSTRACT

A recording device for recording a program includes a display, a setting unit, a recording unit, a controlling unit, and a detecting unit. The setting unit sets recording parameters in response to users' operations. The recording unit records the program according to the set recording parameters and generates a control signal when the recording process for recording the program is finished. The control unit displays an indicator on the display to indicate the recorded program in response to the control signal. The detection unit detects whether the recorded program is opened. The control unit removes the indicator corresponding to the recorded program when the recorded program is detected to be opened. A method for recording a program is also provided.

### BACKGROUND

1. Technical Field

The present disclosure relates to program recording technologies, and more particularly to a recording device and method for recording television (TV) programs.

2. Description of Related Art

A user cannot comfortably watch two television (TV) programs simultaneously. A recording device can be used to record the TV programs when the user is absent or watching another program. The user can then watch the recorded TV programs at a later time. However, if there are a number of recorded TV programs, the users may have to go back and forth to ascertain which recorded TV programs are which and this is tedious and time consuming.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of a recording device in accordance with an embodiment; the recording device includes a setting unit.

FIG. 2 is a block diagram of the setting unit in FIG. 1.

FIG. 3 is a flowchart of a method for recording a TV program in accordance with an embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

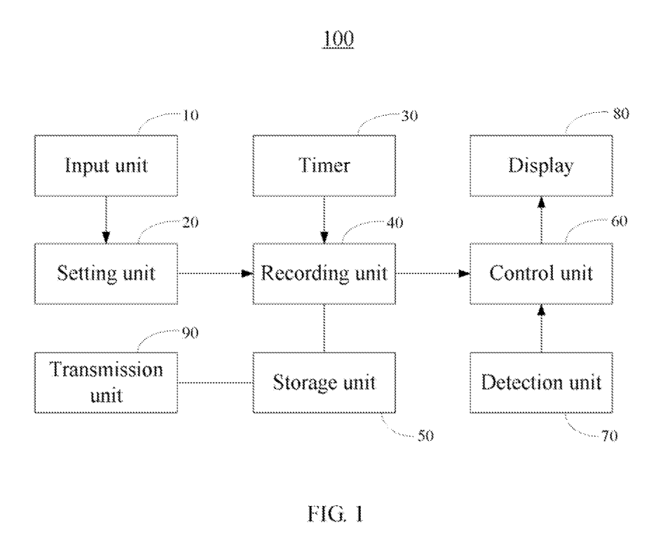

FIG. 1 shows a recording device 100 for recording a TV program, for example. After the recording process of the program is finished, the recording device 100 displays an indicator corresponding to the recorded program before the recorded program has been opened by users, to prompt users that the recorded program has still not been played. The indicator can be an indicator, a flashlight, or the like. The recording device 100 further deletes or removes the indicator when the recorded program is opened. The recording device 100 can be a television, a computer, or the like. In the embodiment, the recording device 100 is a television. The recording device 100 includes an input unit 10, a setting unit 20, a timer 30, a recording unit 40, a storage unit 50, and a control unit 60. The recording device 100 further includes a detection unit 70, a display 80, and a transmission unit 90. The display 80 is adapted to display indicators, images, and videos, for example.

The input unit 10 receives manual operations and generates instructions for controlling the recording device 100. The input unit 10 can be buttons/keys, or a touch panel mounted on a housing of the recording device 100. The input unit 10 can also be a remote control for the recording device 100.

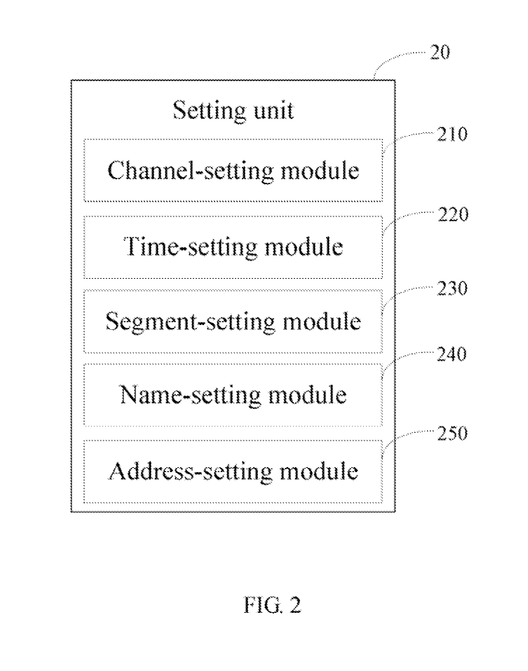

The setting unit 20 sets recording parameters in response to manual operations. The recording parameters includes the desired channel corresponding to the to-be-recorded TV program, a start time S and an end time T for recording the to-be-recorded TV program, a segment condition, name and address of the to-be-recorded TV program when being stored. FIG. 2 shows that the setting unit 30 includes a channel-setting module 210, a time-setting module 220, a segment-setting module 230, a name-setting module 240, and an address-setting module 250. The channel-setting module 210 provides a channel list including a number of channels, for example, an electric program guide (EPG), for allowing users to select the desired channel. The time-setting module 220 sets the start time S and the end time T for recording the to-be-recorded TV program. The segment-setting module 230 allows users to set the segment condition. The segment condition can include a time period and a file size value. In one embodiment, the time period may be 10 minutes, and the file size value may be 10 megabytes. The name-setting module 17 sets the storing name of the segment files, such as, 001, a1, and b1, for example. When the storing name is set, the segment files may be displayed in turn with 001, 002, 003 . . . , or a1, a2, a3 . . . , or b1, b2, b3 . . . . The address-setting module 250 allows users to set the storing address of the to-be-recorded program. In the embodiment, the default address is the address of the storage unit 50. When the default address is selected, the segment files are orderly stored in the storage unit 50. In another embodiment, the address may be set to a remote storage device (not shown) capable of communicating with the recording device 100. As a result, users can command the remote storage device to watch or download the recorded program. Furthermore, because of the large capacity of the remote storage unit, the limitation of the storage unit 50 was avoided.

The recording unit 40 records the to-be-recorded TV program according to the recording parameters and generates a control signal when the recording process of the to-be-recorded TV program finishes. In detail, the recording unit 40 switches to the desired channel set by the channel-setting module 210, and further records the to-be-recorded TV program when the time timed by the timer 30 reaches the start time S. When recording the TV program, the recording module 14 records the TV program according to the segment condition of the parameters. For example, if a segment condition is set to be 10 minutes, the TV program is recorded for 10 minutes, and stored in the storage unit 50 named 001 (a1). The next TV program then starts to be recorded for 10 minutes and is stored in the storage unit 50 named 002 (a2). When the last TV program is less than 10 minutes, but the time reaches the end time T, the recording module 40 also stops recording, and transmits the last TV program to the storage unit 50. All the segment files can be stored in the storing module 14 named 001, 002, 003 . . . , or a1, a2, a3 ...

The storage unit 50 stores the recording parameters and the segment files. In one embodiment, the segment files are listed in turn.

The control unit 60 displays an indicator on the display 80 when receiving the control signal from the recording unit 40, to indicate that the recording process of the to-be-recorded TV program has been finished. The control unit 60 further establishes a link between the indicator and the address where the TV program is stored. The indicator can be a reduction of one of frames of the TV program, or a file with the name of to-be-recorded program. To make the indicator attractive, the indicator in the embodiment is dynamically displayed in a predetermined region of the display 80. For example, the indicator moves along the rim of the display 80 repeatedly, or flashes.

The detection unit 70 detects that the recorded TV program is opened, and generates a detection signal. The control unit 60 further deletes or removes the indicator corresponding to the TV program, which is opened in response to the detecting signal. As a result, only indicators corresponding to the recorded TV programs not opened are displayed on the display 80, and users are aware whether there are desired TV programs, which have been recorded but not opened.

When the storing address is set to be the remote storage device, the transmitting unit 90 transmits the segment files to the remote storage device in turn. Therefore, users of the second electronic device 30 can enter the remote storage device and watch or download the recorded TV program.

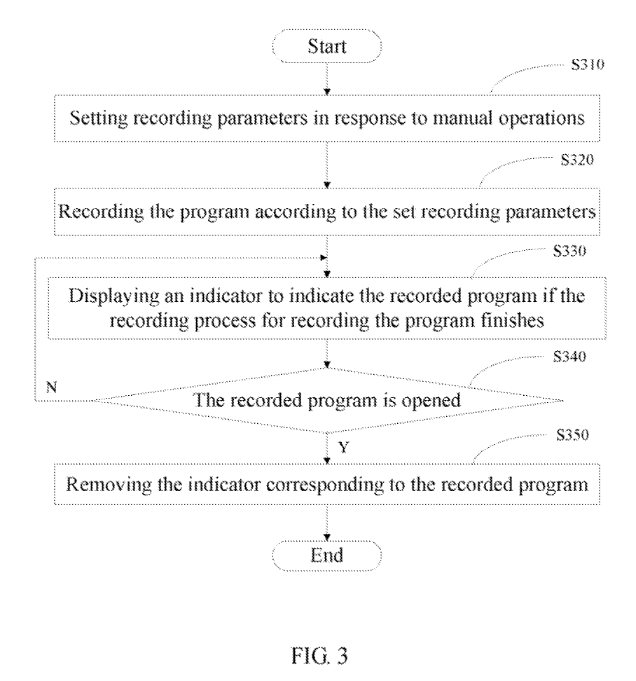

FIG. 3 is a flowchart illustrating one embodiment of a method for recording a

TV program. The method includes the following steps:

In step S310, the setting module 20 sets the recording parameters in response to manual operations and stores the recording parameters in the storing unit 50. The recording parameters includes the desired channel corresponding to the to-be-recorded program, a start time S and an end time T for recording the to-be-recorded program, the size of each section of the to-be-recorded program, name and address of the to-be-recorded program when being stored. In one embodiment, the operating flow parameters may be programmed through a user interface displayed in the display 80. For example, if there is a basketball match on TV channel A from 19:00 to 20:10, the segment condition is the period of 10 minutes, and the segment files are named at a1, a2, a3 . . . .

In step S320, the recording unit 40 records the to-be-recorded program according to the recording parameters and generates a control signal when the recording process of the to-be-recorded program finishes.

In step S330, the control unit 60 controls an indicator to display on the display 80 when receiving the control signal from the recording unit 40, indicating that the recording process of the to-be-recorded program has finished.

In step S340, the detection unit 70 detects whether the recorded program is opened. When the recorded TV program is detected to be opened, the procedure goes to step S350. When the recorded TV program is not opened, the procedure returns to step S330.

In step S350, the control unit 60 deletes or removes the indicator corresponding to the TV program, which is opened. As a result, only indicators corresponding to the recorded TV programs not opened are displayed on the display 80, and users are aware if there are desired TV programs, which have been recorded but not opened.

Although information as to, and advantages of, the present embodiments have been set forth in the foregoing description, together with details of the structures and functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. A recording device for recording a program, comprising;
a display;
a setting unit for setting recording parameters in response to users' operations;
a recording unit for recording the program according to the set recording parameters and generating a control signal when the recording process for recording the program is finished;
a control unit displaying an indicator on the display to indicate the recorded program in response to the control signal; and
a detection unit detecting whether the recorded program is opened;
wherein the control unit removes the indicator corresponding to the recorded program when the recorded program is detected to be opened.

2. The recording device of claim 1, wherein the recording parameters comprises at least the desired channel corresponding to the program, a start time and an end time for recording the program, segment condition, storing name and address of the program.

3. The recording device of claim 2, wherein the setting unit comprises a channel-setting module for providing a channel list comprising a number of channels to allow users to select the desired channel, a time-setting module for setting the start time and the end time for recording the program, a segment-setting module for allowing users to set the segment condition, a name-setting module for setting the storing name of the recorded program, and an address-setting module for allowing users to set the storing address of the program.

4. The recording device of claim 3, wherein the segment condition comprises a time period, and the program is recorded by the recording unit for the time period.

5. The recording device of claim 3, wherein the segment condition comprises a file size value, and the program is recorded by the recording unit in the file size value.

6. The recording device of claim 2, further comprising a storage unit, wherein the storage unit stores the recording parameter.

7. The recording device of claim 6, wherein when the storing address is selected from a group of a default address of the storage unit and an address of a remote storage device communicating with the recording device.

8. The recording device of claim 7, wherein the recording unit stores the recorded program to the storage unit when the storing address is set to be the default address.

9. The recording device of claim 7, further comprising a transmitting unit, wherein the transmitting unit transmits the recorded program to the remote storage device when the storing address is set to be the address of the remote storage device.

10. A method for recording a program, the method being implemented by a recording device, the method comprising:
setting recording parameters in response to users' operations;
recording the program according to the set recording parameters and generating a control signal when the recording process for recording the program is finished;
displaying an indicator on the display to indicate the recorded program in response to the control signal; and
detecting whether the recorded program is opened;
removing the indicator corresponding to the recorded program when the recorded program is detected to be opened.

11. The method according to claim 10, wherein the recording parameters comprises at least the desired channel corresponding to the program, a start time and an end time for recording the program, segment condition, storing name and address of the program.

12. The method according to claim 11, wherein the segment condition comprises a time period, and the program is recorded for the time period.

13. The method of claim 12, wherein the segment condition comprises a file size value, and the program is recorded in the file size value.

14. The method of claim 11, further comprising:
the electronic device providing a storage device;
setting the storage device as the default address for storing the recorded program; and
storing the recorded program to the storage device.

15. The method of claim 11, further comprising:
providing a remote storage device communicating with the recording device;
setting the remote storage device as the storing address for storing the recorded program; and
transmitting the recorded program to the remote storage device.
